(19) United States
(12) Patent Application Publication
(10) Pub. No.: US 2014/0225699 A1
(43) Pub. Date: Aug. 14, 2014

(54) TRANSFORMER

(71) Applicant: MURATA MANUFACTURING CO., LTD., Kyoto (JP)

(72) Inventors: Sayaka SEKIGUCHI, Nagaokakyo-shi (JP); Kosuke ISHIDA, Nagaokakyo-shi (JP)

(73) Assignee: MURATA MANUFACTURING CO., LTD., Kyoto (JP)

(21) Appl. No.: 14/149,656

(22) Filed: Jan. 7, 2014

(30) Foreign Application Priority Data
Feb. 14, 2013 (JP) 2013-026362

(51) Int. Cl. H01F 27/33; H01F 27/28

(52) U.S. Cl. CPC H01F 27/33; H01F 27/2804
USPC 336/192

(57) ABSTRACT

A transformer includes a first coil spiraling inwardly in a second direction. A second coil spirals along the first coil on the outside relative to the first coil. First and second external electrodes are provided in third and fourth directions relative to a first line passing through a gravity center of the first coil and an outer end thereof, respectively, the third direction being perpendicular to the first line, and the fourth direction being opposite thereto. First and second lead-out conductors are connected to the outer end of the first and the second coil, respectively, and electrically connected to the first and the second external electrodes, respectively. Both coils spiral along each other throughout their lengths. By spiraling in the second direction, the first coil is, at the outer end, oriented in a fourth direction.

### CROSS REFERENCE TO RELATED APPLICATIONS

This application claims benefit of priority to Japanese Patent Application No. 2013-026362 filed on Feb. 14, 2013, the entire content of which is incorporated herein by reference.

### TECHNICAL FIELD

The present technical field relates to transformers, more particularly to a transformer including two coils.

### BACKGROUND

As an disclosure related to a conventional transformer, a common-mode noise filter described in, for example, Japanese Patent Laid-Open Publication No. 2006-24772 is known. FIG. 10 is a configuration diagram of the common-mode noise filter 500 described in Japanese Patent Laid-Open Publication No. 2006-24772.

The common-mode noise filter 500 includes a first coil 510, a second coil 520, lead-out portions 511, 512, 521, and 522, and external electrodes 513, 514, 523, and 524. The first coil 510 and the second coil 520 have the same spiral shape. The second coil 520, when viewed in a plan view, is positioned so as to deviate slightly from the first coil 510.

The external electrode 513 is provided on the left side surface. The external electrode 523 is provided below the external electrode 513 on the left side surface. The external electrode 514 is provided on the right side surface. The external electrode 524 is provided below the external electrode 514 on the right side surface. The lead-out portion 511 connects the first coil 510 and the external electrode 513. The lead-out portion 512 connects the first coil 510 and the external electrode 514. The lead-out portion 521 connects the second coil 520 and the external electrode 523. The lead-out portion 522 connects the second coil 520 and the external electrode 524.

In the common-mode noise filter 500, the first coil 510 and the second coil 520 have the same shape, and therefore have the same length. As a result, the first coil 510 and the second coil 520 can be approximated in terms of their inductance values.

However, the common-mode noise filter 500 has an issue in that it is liable to cause a difference between the first coil 510 and the second coil 520 in an inductance value. More specifically, the lead-out portion 511 is led out toward the upper left. Accordingly, a current it flowing through the lead-out portion 511 is directed in the opposite direction to a current i2 flowing near the lead-out portion 511 within the first coil 510. As a result, the magnetic field that is generated near the lead-out portion 511 within the first coil 510 is directed in the opposite direction to the magnetic field that is generated by the lead-out portion 511. Therefore, the inductance value of the first coil 510 decreases.

On the other hand, the lead-out portion 521 is led out toward the lower left. Accordingly, a current i3 flowing through the lead-out portion 521 is directed in the same direction as a current i4 flowing near the lead-out portion 521 within the second coil 520. As a result, the magnetic field that is generated near the lead-out portion 521 within the second coil 520 is directed in the same direction as the magnetic field that is generated by the lead-out portion 521. Therefore, the inductance value of the second coil 520 increases. Thus, the common-mode noise filter 500 is liable to cause a difference between the first coil 510 and the second coil 520 in an inductance value.

### SUMMARY

Therefore, an object of the present disclosure provides a transformer capable of making inductance values of two coils thereof approximated.

A transformer according to an embodiment of the present disclosure includes: a body; a first coil conductor that is provided in the body, and, when viewed in a plan view in a first predetermined direction, spirals inwardly in a second predetermined direction; a second coil conductor that is provided in the body, and, when viewed in a plan view in the first predetermined direction, spirals along the first coil conductor on the outside relative to the first coil conductor; a first external electrode that, when viewed in a plan view in the first predetermined direction, is provided on a surface of the body in a third predetermined direction relative to a first line passing through a gravity center of the first coil conductor and an outer end of the first coil conductor, the third predetermined direction being perpendicular to the first line; a first lead-out conductor that is connected to the outer end of the first coil conductor and is electrically connected to the first external electrode; a second external electrode that, when viewed in a plan view in the first predetermined direction, is provided on a surface of the body in a fourth predetermined direction relative to the first line, the fourth predetermined direction being opposite to the third predetermined direction; and a second lead-out conductor that is connected to the outer end of the second coil conductor and is electrically connected to the second external electrode, wherein the first coil conductor and the second coil conductor spiral along each other throughout their lengths, and by spiraling in the second predetermined direction, the first coil conductor is, at the outer end, oriented toward a fourth predetermined direction.

### BRIEF DESCRIPTION OF THE DRAWINGS

FIG. 1 is an external perspective view of a transformer.

FIG. 2 is an exploded perspective view of a laminate of the transformer.

FIG. 3 is a plan view of one coil conductor and one set of lead-out conductors of the transformer.

FIG. 4 is a plan view of the other coil conductor and the other set of lead-out conductors of the transformer.

FIG. 5 is an overlapping view of the both coil conductors and the both set of lead-out conductors.

FIG. 6 is a graph showing the relationship between the frequency and the phase differences for S21 and S43 in a first model.

FIG. 7 is a graph showing the relationship between the frequency and the phase differences for S21 and S43 in a second model.

FIG. 8 is a graph showing the relationship of the frequency with Sdc21 in the first and second models.

FIG. 9 is a graph showing the relationship between the frequency and the CMRR in the first and second models.

FIG. 10 is a configuration diagram of a common-mode noise filter described in Japanese Patent Laid-Open Publication No. 2006-24772.

### DETAILED DESCRIPTION

Hereinafter, a transformer according to an embodiment of the present disclosure will be described with reference to the drawings.

### Configuration of Transformer

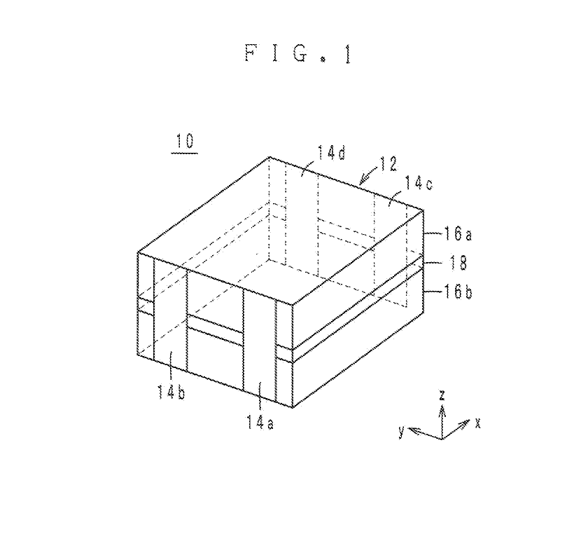

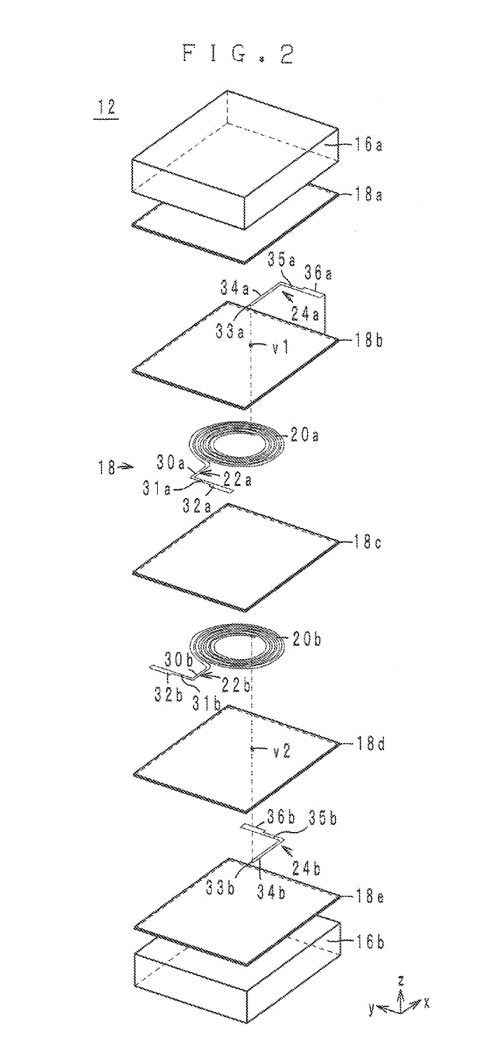

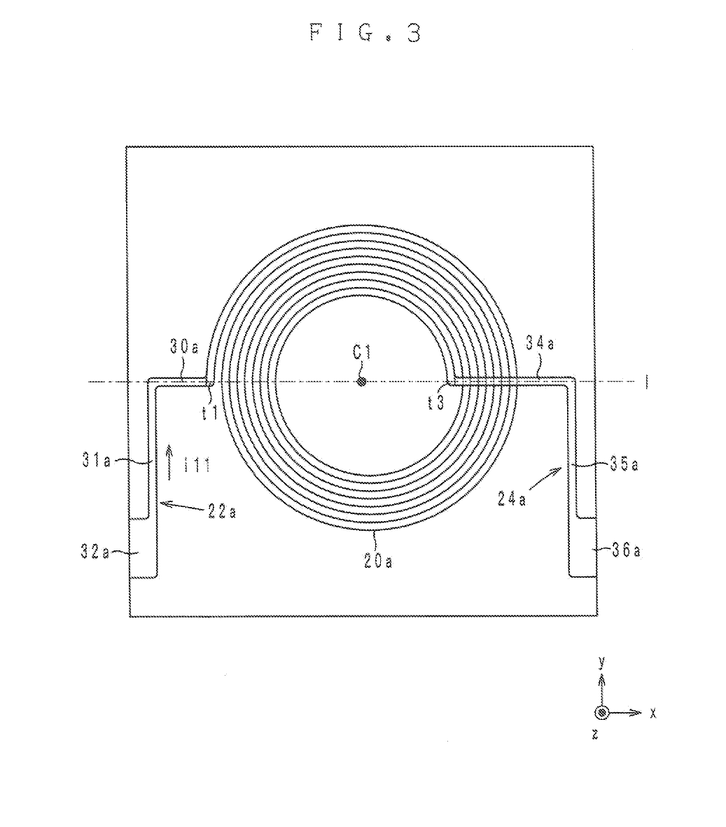

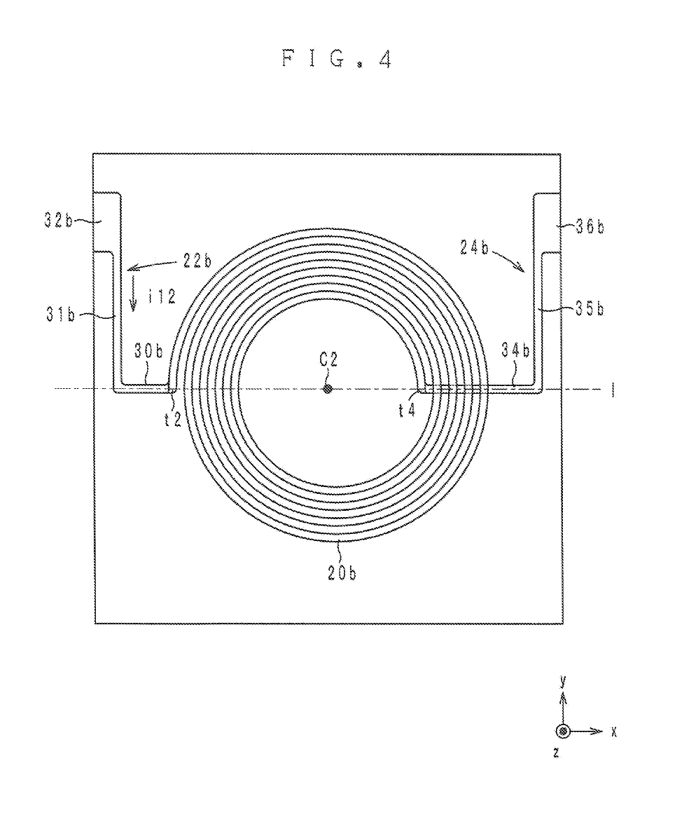

First, the configuration of the transformer will be described with reference to the drawings. FIG. 1 is an external perspective view of the transformer 10. FIG. 2 is an exploded perspective view of a laminate 12 of the transformer 10. FIG. 3 is a plan view of one coil conductor 20a and one set of lead-out conductors 22a and 24a of the transformer 10. FIG. 4 is a plan view of the other coil conductor 20b and the other set of lead-out conductors 22b and 24b of the transformer 10. FIG. 5 is an overlapping view of both coil conductors 20a and 20b and both sets of the lead-out conductors 22a, 22b and the lead-out conductors 24a, and 24b. In the following, the direction of lamination of the laminate 12 will be defined as a z-axis direction. Moreover, when viewed in a plan view in the z-axis direction, the directions in which two sides of the laminate 12 extend will be defined as x- and y-axis directions. The x-, y-, and z-axis directions are perpendicular to one another.

The transformer 10 includes the laminate 12, external electrodes 14a to 14d, the coil conductors 20a and 20b, the lead-out conductors 22a, 22b, 24a, and 24b, and via-hole conductors v1 and v2, as shown in FIGS. 1 and 2.

The laminate 12 is in the shape of a substantially rectangular solid, and includes magnetic portions 16a and 16b and a non-magnetic portion 18, as shown in FIGS. 1 and 2. The magnetic portions 16a and 16b are made of a magnetic material, such as ferrite, and are in the shape of substantially rectangular solids. Moreover, the non-magnetic portion 18 is formed by laminating non-magnetic layers (i.e., insulator layers) 18a to 18e in this order, from the positive side in the z-axis direction. The non-magnetic layers 18a to 18e are substantially rectangular, and are made of a non-magnetic material including borosilicate glass and ceramic filler. In the following, the surfaces of the non-magnetic layers 18a to 18e on the positive side in the z-axis direction will be referred to as the front faces, and the surfaces of the non-magnetic layers 18a to 18e on the negative side in the z-axis direction will be referred to as the back faces.

The coil conductors 20a and 20b are provided in the laminate 12, and electromagnetically coupled to each other. More specifically, the coil conductor 20a is a linear conductor provided on the front face of the non-magnetic layer 18c, and when viewed in a plan view in the z-axis direction, it has a spiral shape winding clockwise inwardly, as shown in FIGS. 2 and 3. The coil conductor 20b is a linear conductor provided on the front face of the non-magnetic layer 18d, which is located on the negative side in the z-axis direction relative to the non-magnetic layer 18c with the coil conductor 20a provided thereon, as shown in FIGS. 2 and 4, and when viewed in a plan view in the z-axis direction, the coil conductor 20b has a spiral shape winding clockwise inwardly. Moreover, the coil conductor 20b, when viewed in a plan view in the z-axis direction, spirals along the coil conductor 20a on the outside relative to the coil conductor 20a, as shown in FIGS. 2 and 5. In the present embodiment, the coil conductor 20a and the coil conductor 20b overlap in part with each other in the width direction thereof. Moreover, the coil conductor 20a and the coil conductor 20b spirally wind along each other throughout their lengths. Accordingly, the outer end t1 of the coil conductor 20a and the outer end t2 of the coil conductor 20b are adjacent to each other, and the inner end t3 of the coil conductor 20a and the inner end t4 of the coil conductor 20b are adjacent to each other. Moreover, the coil conductor 20b is longer than the coil conductor 20a.

Furthermore, the ends t1 and t3 and the gravity center C1 of the coil conductor 20a are aligned in the x-axis direction. The gravity center C1 refers to the gravity center of the coil conductor 20a as viewed in a plan view in the z-axis direction. In the present embodiment, the gravity center C1 substantially coincides with the center of the coil conductor 20a. The end t1 is positioned on the negative side in the x-axis direction relative to the gravity center C1. Accordingly, by spiraling clockwise, the coil conductor 20a has a directional component toward the positive side in the y-axis direction at the outer end t1. That is, the coil conductor 20a starts spiraling by extending from the outer end t1 toward the positive side in the y-axis direction. The end t3 is positioned on the positive side in the x-axis direction relative to the gravity center C1.

[Furthermore, the ends t2 and t4 and the gravity center C2 of the coil conductor 20b are aligned in the x-axis direction. The gravity center C2 refers to the gravity center of the coil conductor 20b as viewed in a plan view in the z-axis direction. In the present embodiment, the gravity center C2 substantially coincides with the center of the coil conductor 20b. The end t2 is positioned on the negative side in the x-axis direction relative to the gravity center C2. Accordingly, by spiraling clockwise, the coil conductor 20b has a directional component toward the positive side in the y-axis direction at the outer end t2. That is, the coil conductor 20b starts spiraling by extending from the outer end t2 toward the positive side in the y-axis direction. The end t4 is positioned on the positive side in the x-axis direction relative to the gravity center C2.

Note that in the present embodiment, the gravity center C1 and the gravity center C2 substantially coincide with each other when viewed in a plan view in the z-axis direction. Accordingly, the ends t1 to t4 and the gravity centers C1 and C2 are aligned in the x-axis direction. In the following, a line that passes through the ends t1 to t4 and the gravity centers C1 and C2 will be referred to as “line 1”. Line 1 extends in the x-axis direction.

The external electrodes 14a and 14b are provided in the form of rectangles extending in the z-axis direction on the side surface of the laminate 12 that is located on the negative side in the x-axis direction, as shown in FIG. 1. The external electrode 14a, when viewed in a plan view in the z-axis direction, is positioned on the negative side in the y-axis direction relative to line 1, as shown in FIG. 5. The external electrode 14b, when viewed in a plan view in the z-axis direction, is positioned on the positive side in the y-axis direction relative to line 1, as shown in FIG. 5. The external electrode 14a and the external electrode 14b have a line-symmetrical relationship with respect to line 1.

The external electrodes 14c and 14d are provided in the form of rectangles extending in the z-axis direction on the side surface of the laminate 12 that is located on the positive side in the x-axis direction, as shown in FIG. 1. The external electrode 14c, when viewed in a plan view in the z-axis direction, is positioned on the negative side in the y-axis direction relative to line 1, as shown in FIG. 5. The external electrode 14d, when viewed in a plan view in the z-axis direction, is positioned on the positive side in the y-axis direction relative to line 1, as shown in FIG. 5. The external electrode 14c and the external electrode 14d have a line-symmetrical relationship with respect to line 1.

The lead-out conductor 22a is connected to the outer end t1 of the coil conductor 20a, and is electrically connected to the external electrode 14a, as shown in FIGS. 2, 3, and 5. More specifically, the lead-out conductor 22a includes lead-out portions 30a and 31a, and a connection 32a. The lead-out portion 30a extends on the front face of the non-magnetic layer 18c from the outer end t1 of the coil conductor 20a toward the negative side in the x-axis direction. However, the lead-out portion 30a is not led out to the side surface of the laminate 12 that is located on the negative side in the x-axis direction. The lead-out portion 31a extends from the end of the lead-out portion 30a that is located on the negative side in the x-axis direction toward the negative side in the y-axis direction. Accordingly, the lead-out portions 30a and 31a form an L-like shape. The connection 32a, which is located on the front face of the non-magnetic layer 18c, is connected to the end of the lead-out portion 31a that is located on the negative side in the y-axis direction, and the connection 32a is led out to the side of the non-magnetic layer 18c that is located on the negative side in the x-axis direction. Accordingly, the connection 32a is exposed in the form of a line extending in the y-axis direction, at the side surface of the laminate 12 that is located on the negative side in the x-axis direction. As a result, the connection 32a is connected to the external electrode 14a.

The lead-out conductor 22b is connected to the outer end t2 of the coil conductor 20b, and is electrically connected to the external electrode 14b, as shown in FIGS. 2, 4, and 5. More specifically, the lead-out conductor 22b includes lead-out portions 30b and 31b and a connection 32b. The lead-out portion 30b extends on the front face of the non-magnetic layer 18d from the outer end t2 of the coil conductor 20b toward the negative side in the x-axis direction. However, the lead-out portion 30b is not led out to the side surface of the laminate 12 that is located on the negative side in the x-axis direction. The lead-out portion 31b extends from the end of the lead-out portion 30b that is located on the negative side in the x-axis direction toward the positive side in the y-axis direction. Accordingly, the lead-out portions 30b and 31b form an L-like shape. The connection 32b, which is located on the front face of the non-magnetic layer 18d, is connected to the end of the lead-out portion 31b that is located on the positive side in the y-axis direction, and the connection 32b is led out to the side of the non-magnetic layer 18d that is located on the negative side in the x-axis direction. Accordingly, the connection 32b is exposed in the form of a line extending in the y-axis direction, at the side surface of the laminate 12 that is located on the negative side in the x-axis direction. As a result, the connection 32b is connected to the external electrode 14b.

Here, the lead-out conductor 22a and the lead-out conductor 22b are in a symmetrical relationship with respect to line 1. Accordingly, the lead-out portion 30a and the lead-out portion 30b have approximately the same length. Moreover, the lead-out portion 31a and the lead-out portion 31b have approximately the same length.

The lead-out conductor 24a is connected to the inner end t3 of the coil conductor 20a, and is electrically connected to the external electrode 14c, as shown in FIGS. 2, 3, and 5. More specifically, the lead-out conductor 24a includes lead-out portions 34a and 35a and a connection 36a. The lead-out portion 34a extends on the front face of the non-magnetic layer 18b from the inner end t3 of the coil conductor 20a toward the positive side in the x-axis direction. However, the lead-out portion 34a is not led out to the side surface of the laminate 12 that is located on the positive side in the x-axis direction. The lead-out portion 35a extends from the end of the lead-out portion 34a that is located on the positive side in the x-axis direction toward the negative side in the y-axis direction. Accordingly, the lead-out portions 34a and 35a form an L-like shape. The connection 36a, which is located on the front face of the non-magnetic layer 18b, is connected to the end of the lead-out portion 35a that is located on the negative side in the y-axis direction, and the connection 36a is led out to the side of the non-magnetic layer 18b that is located on the positive side in the x-axis direction. Accordingly, the connection 36a is exposed in the form of a line extending in the y-axis direction, at the side surface of the laminate 12 that is located on the positive side in the x-axis direction. As a result, the connection 36a is connected to the external electrode 14c.

The lead-out conductor 24b is connected to the inner end t4 of the coil conductor 20b, and is electrically connected to the external electrode 14d, as shown in FIGS. 2, 4, and 5. More specifically, the lead-out conductor 24b includes lead-out portions 34b and 35b and a connection 36b. The lead-out portion 34b extends on the front face of the non-magnetic layer 18e from the inner end t4 of the coil conductor 20b toward the positive side in the x-axis direction. However, the lead-out portion 34b is not led out to the side surface of the laminate 12 that is located on the positive side in the x-axis direction. The lead-out portion 35b extends from the end of the lead-out portion 34b that is located on the positive side in the x-axis direction toward the positive side in the y-axis direction. Accordingly, the lead-out portions 34b and 35b form an L-like shape. The connection 36b, which is located on the front face of the non-magnetic layer 18e, is connected to the end of the lead-out portion 35b that is on the positive side in the y-axis direction, and the connection 36b is led out to the side of the non-magnetic layer 18e that is located on the positive side in the x-axis direction. Accordingly, the connection 36b is exposed in the form of a line extending in the y-axis direction, at the side surface of the laminate 12 that is located on the positive side in the x-axis direction. As a result, the connection 36b is connected to the external electrode 14d.

Here, the lead-out conductor 24a and the lead-out conductor 24b are in a symmetrical relationship with respect to line 1. Accordingly, the lead-out portion 34a and the lead-out portion 34b have approximately the same length. Moreover, the lead-out portion 35a and the lead-out portion 35b have approximately the same length.

The via-hole conductor v1 pierces through the non-magnetic layer 18b in the z-axis direction, so as to connect the inner end t3 of the coil conductor 20a and the end of the lead-out portion 34a that is located on the negative side in the x-axis direction. The via-hole conductor v2 pierces through the non-magnetic layer 18d in the z-axis direction, so as to connect the inner end t4 of the coil conductor 20b and the end of the lead-out portion 34b that is located on the negative side in the x-axis direction.

In the transformer 10 thus configured, a magnetic flux generated by the coil conductor 20a passes through the coil conductor 20b, and a magnetic flux generated by the coil conductor 20b passes through the coil conductor 20a. Accordingly, the coil conductor 20a and the coil conductor 20b are magnetically coupled, so that the coil conductor 20a and the coil conductor 20b constitute a common-mode choke coil. In addition, the external electrodes 14a and 14b are used as input terminals, and the external electrodes 14c and 14d are used as output terminals. Specifically, differential transmission signals are inputted into the external electrodes 14a and 14b, and outputted from the external electrodes 14c and 14d. Moreover, when the differential transmission signals contain common-mode noise, the coil conductors 20a and 20b generate magnetic fluxes in the same direction because of the common-mode noise. As a result, the magnetic fluxes intensify each other, thereby generating impedance to the common-mode noise. Thus, the common-mode noise is transformed into heat, and therefore is prevented from passing through the coil conductors 20a and 20b.

### Effects

The transformer 10 according to the present embodiment allows the inductance value of the coil conductor 20a and the inductance value of the coil conductor 20b to become approximate to each other. More specifically, the external electrode 14a, when viewed in a plan view in the z-axis direction, is provided on the negative side in the y-axis direction relative to line 1. Accordingly, the lead-out conductor 22a extends toward the negative side in the y-axis direction. Therefore, when a current flows clockwise through the coil conductor 20a, a current i11 flows through the lead-out portion 31a toward the positive side in the y-axis direction. As a result, a magnetic field toward the negative side in the z-axis direction is generated on the positive side in the x-axis direction relative to the lead-out portion 31a. On the other hand, when such a current flowing clockwise through the coil conductor 20a occurs, a magnetic field toward the negative side in the z-axis direction is generated within the coil conductor 20a. As a result, in the coil conductor 20a, the magnetic field generated by the lead-out portion 31a and the magnetic field generated by the coil conductor 20a are oriented in the same direction, so that the inductance value of the coil conductor 20a becomes relatively high.

The external electrode 14b, when viewed in a plan view in the z-axis direction, is provided on the positive side in the y-axis direction relative to line 1. Accordingly, the lead-out conductor 22b extends toward the positive side in the y-axis direction. Therefore, when a current flows clockwise through the coil conductor 20b, a current i12 flows through the lead-out portion 31b toward the negative side in the y-axis direction. As a result, a magnetic field toward the positive side in the z-axis direction is generated on the positive side in the x-axis direction relative to the lead-out portion 31b. On the other hand, when such a current flowing clockwise through the coil conductor 20b occurs, a magnetic field toward the negative side in the z-axis direction is generated within the coil conductor 20b. As a result, in the coil conductor 20b, the magnetic field generated by the lead-out portion 31b and the magnetic field generated by the coil conductor 20b are oriented in opposite directions, so that the inductance value of the coil conductor 20b becomes relatively low. In this manner, the lead-out conductors 22a and 22b might cause the inductance value of the coil conductor 20b to be less than the inductance value of the coil conductor 20a.

Therefore, in the transformer 10, the coil conductor 20b, when viewed in a plan view in the z-axis direction, spirals along the coil conductor 20a on the outside relative to the coil conductor 20a. In addition, the coil conductor 20a and the coil conductor 20b spirally wind along each other throughout their lengths. Therefore, the coil conductor 20b is longer than the coil conductor 20a. That is, the magnetic field generated by the coil conductor 20b is stronger than the magnetic field generated by the coil conductor 20a. As a result, the inductance value of the coil conductor 20a and the inductance value of the coil conductor 20b become approximate to each other.

In the case where the transformer 10 is used as a common-mode choke coil, as the inductance value of the coil conductor 20a and the inductance value of the coil conductor 20b become approximate to each other, as described above, the difference between the phases of first and second signals that constitute a differential transmission signal approximates 180 degrees.

Furthermore, in the case where the transformer 10 is used as a common-mode choke coil, as the inductance value of the coil conductor 20a and the inductance value of the coil conductor 20b become approximate to each other, the magnetic flux that a first signal causes the coil conductor 20a to generate and the magnetic flux that a second signal causes the coil conductor 20b to generate are cancelled out efficiently when a differential-mode signal consisting of the first and second signals passes through the transformer 10. Thus, the differential-mode signal is inhibited from being converted into common-mode noise in the transformer 10.

Furthermore, in the case where the transformer 10 is used as a balun, as the inductance value of the coil conductor 20a and the inductance value of the coil conductor 20b become approximate to each other, the transformer 10 starts to output a differential signal consisting of first and second signals which are out of phase by 180 degrees. Thus, common-mode noise is inhibited from being included in output signals.

To more clearly demonstrate the effects achieved by the transformer 10, the present inventors carried out the following computer simulations. The inventors created a first model with the structure of the transformer 10, and a second model in which the coil conductor 20a and the coil conductor 20b of the transformer 10, when viewed in a plan view in the z-axis direction, coincide with each other in an entirely overlapping manner. The first model is a model according to an example, and the second model is a model according to a comparative example. Each of the first and second models was used as a common-mode choke coil, and S-parameters were computed by inputting differential transmission signals to the first and second models. The computed S-parameters were S21, S43, and Sdc21. The parameters S21 and S43 are transmission characteristics of the first and second models. Specifically, the parameter S21 is the ratio of the intensity of a first signal inputted to the external electrode 14a to the intensity of the first signal outputted from the external electrode 14c. The parameter S43 is the ratio of the intensity of a second signal inputted to the external electrode 14b to the intensity of the second signal outputted from the external electrode 14d. The parameter Sdc21 represents the rate of a differential-mode signal being converted into common-mode noise.

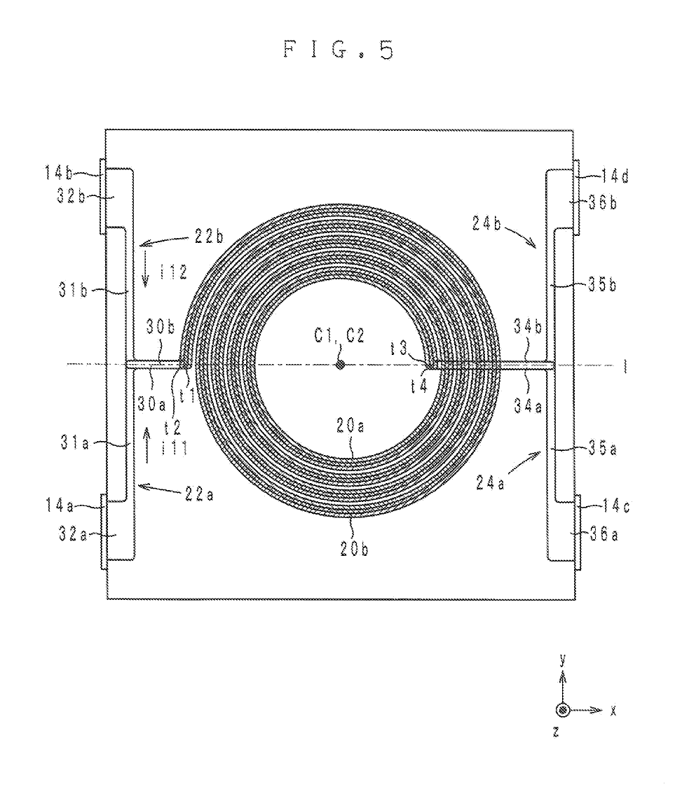

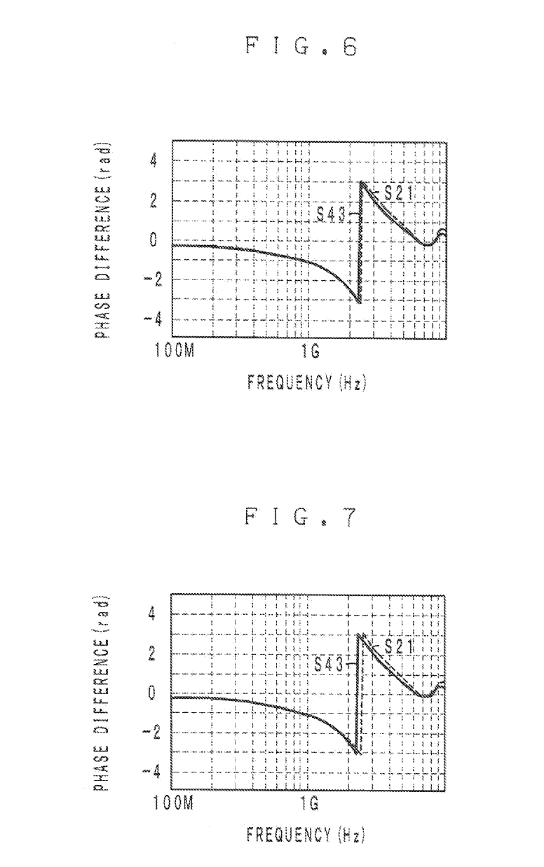

FIG. 6 is a graph showing the relationship between the frequency and the phase differences for the parameters S21 and S43 in the first model. FIG. 7 is a graph showing the relationship between the frequency and the phase differences for the parameters S21 and S43 in the second model. FIG. 8 is a graph showing the relationship of the frequency with the parameter Sdc21 in the first and second models. In FIGS. 6 and 7, the vertical axis represents the phase difference, and the horizontal axis represents the frequency. In FIG. 8, the vertical axis represents the intensity ratio, and the horizontal axis represents the frequency.

From FIG. 7, it can be appreciated that in the second model, the frequency at which the same phase difference occurs varies between S21 and S43. Specifically, it can be appreciated that in the second model, the phase difference between the inputted first signal and the outputted first signal deviates from the phase difference between the inputted second signal and the outputted second signal. Thus, it can be appreciated that in the second model, the phase difference between the first and second signals to be outputted tends to deviate from 180 degrees.

On the other hand, from FIG. 6, it can be appreciated that in the first model, the frequency at which the same phase difference occurs is equal between S21 and S43. Specifically, it can be appreciated that in the first model, the phase difference between the inputted first signal and the outputted first signal is less subject to deviating from the phase difference between the inputted second signal and the outputted second signal. Thus, it can be appreciated that in the first model, the phase difference between the first and second signals to be outputted is less subject to deviating from 180 degrees.

Furthermore, from FIG. 8, it can be appreciated that Sdc21 is lower in the first model than in the second model. Accordingly, it can be appreciated that conversion of the differential-mode signal into common-mode noise is inhibited in the first model more than in the second model.

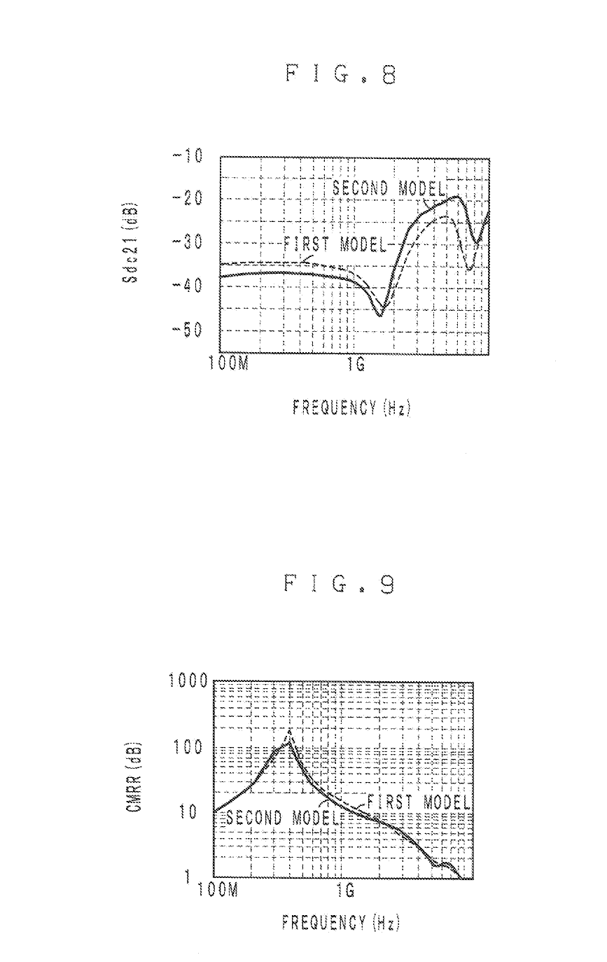

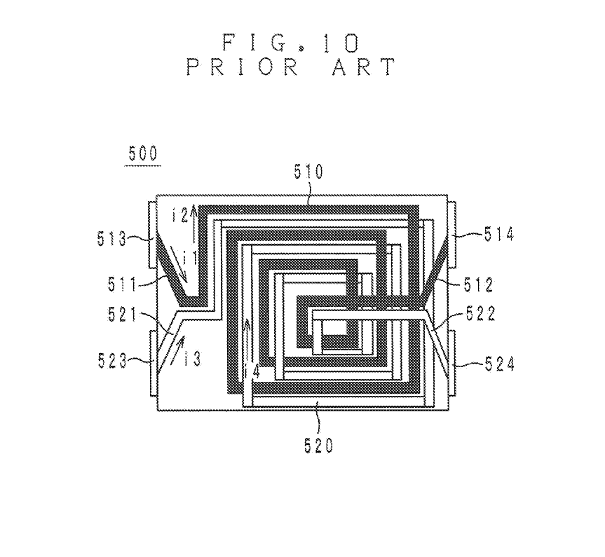

Furthermore, the present inventors carried out the following computer simulations using the first and second models. Specifically, the first and second models were used as baluns, and common-mode rejection ratios (CMRRs) were computed by inputting first signals to the first and second models. FIG. 9 is a graph showing the relationship between the frequency and the CMRR in the first and second models. In FIG. 9, the vertical axis represents the CMRR, and the horizontal axis represents the frequency.

From FIG. 9, it can be appreciated that the CMRR is higher in the first model than in the second model. Thus, it can be appreciated that the intensity of the common-mode component in an output signal is lower in the first model than in the second model.

### Other Embodiments

The present disclosure is not limited to the transformer 10, and variations can be made within the spirit and scope of the disclosure.

Note that the transformer 10 may be provided with a core made of a magnetic material and piercing through the gravity center of the coil conductor 20a and the gravity center of the coil conductor 20b in the z-axis direction. This renders it possible to increase a coefficient of coupling between the coil conductor 20a and the coil conductor 20b.

Note that in the transformer 10, the coil conductor 20a and the coil conductor 20b, when viewed in a plan view in the z-axis direction, overlap in part in the width direction, as shown in FIG. 5. However, the coil conductor 20a and the coil conductor 20b do not necessarily overlap in the width direction. In such a case, when viewed in a plan view in the z-axis direction, the coil conductor 20b is positioned between adjacent winds of the coil conductor 20a, and the coil conductor 20a is positioned between adjacent winds of the coil conductor 20b. In this configuration, the coil conductor 20a and the coil conductor 20b do not overlap each other, resulting in a reduced difference in thickness in the z-axis direction between the area in which the coil conductor 20a is provided and the area in which the coil conductor 20b is provided. Thus, the laminate 12 can be inhibited from having irregularities formed therein.

Furthermore, in the case where the coil conductors 20a and 20b are to be provided so as not to overlap in the z-axis direction, the coil conductors 20a and 20b may be provided on the same insulator layer.

Furthermore, the coil conductors 20a and 20b have circular outlines, but they may have rectangular or elliptical outlines.

Note that a plate-like substrate may be used in place of the laminate 12. In such a case, the coil conductor 20a is provided on the principal surface of the substrate that is located on the positive side in the z-axis direction, and the coil conductor 20b is provided on the principal surface of the substrate that is located on the negative side in the z-axis direction.

Although the present disclosure has been described in connection with the preferred embodiment above, it is to be noted that various changes and modifications are possible to those who are skilled in the art. Such changes and modifications are to be understood as being within the scope of the disclosure.

What is claimed is:

1. A transformer comprising:
a body;
a first coil conductor provided in the body, and, when the first coil conductor is viewed in a plan view in a first predetermined direction, the first coil conductor spirals inwardly in a second predetermined direction;
a second coil conductor provided in the body, and, when the second coil conductor is viewed in a plan view in the first predetermined direction, the second coil conductor spirals along the first coil conductor on the outside relative to the first coil conductor;
a first external electrode, when viewed in a plan view in the first predetermined direction, being provided on a surface of the body in a third predetermined direction relative to a first line passing through a gravity center of the first coil conductor and an outer end of the first coil conductor, the third predetermined direction being perpendicular to the first line;
a first lead-out conductor connected to the outer end of the first coil conductor and being electrically connected to the first external electrode;
a second external electrode, when viewed in a plan view in the first predetermined direction, being provided on a surface of the body in a fourth predetermined direction relative to the first line, the fourth predetermined direction being opposite to the third predetermined direction; and
a second lead-out conductor connected to the outer end of the second coil conductor and being electrically connected to the second external electrode,
the first coil conductor and the second coil conductor spiraling along each other throughout their lengths, and
by spiraling in the second predetermined direction, the first coil conductor is, at the outer end, oriented toward a fourth predetermined direction.

2. The transformer according to claim 1, wherein the body is a laminate formed by laminating a plurality of insulator layers.

3. The transformer according to claim 2, wherein the first coil conductor and the second coil conductor are provided on different insulator layers.

4. The transformer according to claim 1, wherein the first lead-out conductor and the second lead-out conductor are approximately in a line-symmetrical relationship with respect to the first line.
